(19) United States
(12) Patent Application Publication
(10) Pub. No.: US 2026/0199752 A1
(43) Pub. Date: Jul. 16, 2026

(54) Sound-Dampening Pad for a Paddle

(71) Applicants: Dan Rinicella, SR., Aurora, OH (US); Timothy Garner, Solon, OH (US)

(72) Inventors: Dan Rinicella, SR., Aurora, OH (US); Timothy Garner, Solon, OH (US)

(21) Appl. No.: 19/564,668

(22) Filed: Mar. 12, 2026

Related U.S. Application Data
(63) Continuation-in-part of application No. 18/763,565, filed on Jul. 3, 2024, now Pat. No. 12,576,319.

(51) Int. Cl. A63B 60/54; A63B 59/42; A63B 102/08; B32B 7/12; B32B 27/08; B32B 27/40; B32B 37/10; B32B 37/12

(52) U.S. Cl. CPC A63B 60/54; A63B 59/42; B32B 7/12; B32B 27/08; B32B 27/40; B32B 37/10; A63B 2102/08; A63B 2209/10; B32B 2037/1223; B32B 2250/02; B32B 2250/24; B32B 2305/022; B32B 2307/7376; B32B 2375/00

(57) ABSTRACT

A sound-dampening pad is configured to be removably adhered to a face of a paddle, such as a pickleball paddle, to reduce sound produced by ball impact. The pad includes a cushion or damping layer and a repositionable adhesive backing that enables removal and reapplication without permanent modification of the paddle. In some embodiments, the damping layer comprises a fibrous acoustic layer and/or a lightweight polymer foam layer including microcellular viscoelastic polyurethane foam and/or expanded thermoplastic polyurethane foam. In some embodiments, the pad includes a low-drag face layer comprising a polymer film, such as a thermoplastic polyurethane film, that may be textured and/or perforated and may be colored or printed. Edge features including a bevel and/or an edge seal and methods of making the pad are also disclosed.

### BACKGROUND OF THE INVENTION

The sport of pickleball has grown in popularity, which has resulted in numerous pickleball courts being constructed, often near residential areas. Some residents have complained about the noise that comes from a hard pickleball paddle striking a hard pickleball. This has lead to some cities passing noise ordinances regarding pickleball.

In addition, the national pickleball governing body has recently created a “quiet category” of pickleball that uses any number of techniques to reduce the noise resulting from playing pickleball. This includes paddles that are constructed from different materials than regular pickleball paddles, or paddles that have permanent padding as part of their construction as well as balls and accessories, such as paddle covers/sleeves/overlays. Thus, there exists a need for a quieter pickleball paddle.

### BRIEF SUMMARY OF THE INVENTION

The invention relates to an acoustic fabric pad affixed to a paddle to reduce sound. In particular, the invention is directed to a pad for a pickleball paddle, but is not limited to such use, and could adapted for any paddle sport that creates noise from striking a ball with a paddle.

A exemplary sound-dampening pad for a paddle used in a paddle sport that uses a ball, the pad includes a cushion material disposed on a first side of the pad; an adhesive disposed on a second side of the pad configured to attach the pad the paddle; wherein the cushion material reduces the sound of the paddle striking the ball.

The sound dampening pad can include a pad that is releasably attached to the paddle.

The sound dampening pad can include a pull tab disposed at an edge of the pad for removing the pad from the paddle.

The sound dampening pad can include the pull tab being disposed at a bottom edge of the pad at the top of the handle of the paddle.

The sound dampening pad can include the paddle being a pickleball paddle.

The sound dampening pad can include the cushion material being a polymer.

The sound dampening pad can include the cushion material being a polyester PET acoustic fabric.

The sound dampening pad can include wherein the pad reduces the sound of the paddle striking the ball by 25% or more.

The sound dampening pad can include wherein the pad reduces the sound of the paddle striking the ball by 40% or more.

The sound dampening pad can include wherein the pad reduces the sound of the paddle striking the ball by 50% or more.

An exemplary sound-dampening system for a paddle sport that uses a ball and paddle having first and second striking surfaces, the system including first and second pads, each pad including a cushion material disposed on a first side of the pad; an adhesive disposed on a second side of the pad configured to attach the pad to the paddle; wherein the first pad is attached to the first striking surface of the paddle, and the second pad is attached to the second striking surface of the paddle; wherein the cushion material reduces the sound of the paddle striking the ball.

The sound-dampening system can include pads that are removeable.

The sound-dampening system can include a storage board configured to releasably hold the pads.

The sound-dampening system can include the storage board having first and second opposing sides, each of the opposing sides having a low surface energy layer, whereby when storing the pads, the low surface energy layer is disposed between the pad and the storage board.

The sound-dampening system can include the low surface energy layer being a silicone layer.

### BRIEF DESCRIPTION OF THE SEVERAL VIEWS OF THE DRAWING

FIG. 1 is an exploded perspective view of an exemplary embodiment of the sound absorbing pad and paddle;

FIG. 2 is a cross sectional side view of the pad and paddle of FIG. 1;

FIG. 3 shows alternate exemplary embodiments of the shape of the sound absorbing pad;

FIG. 4 shows alternate exemplary embodiments of the pull tab of the sound absorbing pad;

FIG. 5 is an exploded perspective view an exemplary embodiment of a storage board for the sound absorbing pad; and

FIG. 6 is a cross sectional side view of the storage board of FIG. 5.

### DETAILED DESCRIPTION OF THE INVENTION

The invention relates to an acoustic fabric pad affixed to a paddle to reduce sound. In particular, the invention is directed to a pad for a pickleball paddle, but is not limited to such use, and could adapted for any paddle sport that creates noise from striking a ball with a paddle. The present invention allows a normal pickleball paddle to be adapted to conform to the quiet category requirements, and/or to otherwise reduce the noise generated from striking a ball.

The present invention is a pair of pads that can be affixed to both striking surfaces of a standard pickleball paddle. The pad is composed of sound-dampening padding or cushion material. The padding material can vary—including type, shape, thickness, and density. The padding material can include, e.g., polyester PET acoustic fabric, but is not limited to such materials. By incorporating acoustic materials, the pad absorbs and dampens the sound produced upon impact with the ball, resulting in a quieter playing experience. With noise ordinances and court restrictions on the rise, the present invention addresses these issues.

The pad of the present invention was tested on various paddles with and without the acoustic pad. The results showed that the decibel noise levels were reduced by up to 50% when the pad was installed.

The pad is attached to a user's existing standard pickleball paddle, so there is no need to buy an expensive separate paddle to use when noise is an issue. Thus, the user can choose to use the pad when it is needed. The pad is designed for easy attachment to the paddle, requiring minimal effort for installation and removal, allowing players to change their equipment quickly.

The pad uses a removable adhesive backing that allows the pad to be attached and removed numerous times without leaving a messy residue. This allows a user to play with reduced sound or remove the pad and use the paddle as a standard paddle in a standard pickleball game. The padding material has adhesive backing. A permanent adhesive applied to back of the padding material that is removable and/or re-positionable. This way, the padding can be applied and removed multiple times.

The adhesive is covered with a removable protective covering prior to use (such as, e.g., wax paper). In use, the cover layer is removed, exposing re-positionable adhesive on the side that is applied to paddle. The adhesive allows the padding to be applied and removed multiple times.

The pad is customizable and can be designed to fit various paddle sizes and shapes, ensuring compatibility with different models and preferences. The pad can be modified to a wide range of colors and designs, allowing the user to choose what he or she likes best. The pad is constructed with high-quality materials, the acoustic fabric pad is durable and long-lasting, providing reliable performance over extended use.

The pad is suitable for players of all skill levels, the acoustic fabric pad can be used in various playing conditions, whether indoors or outdoors. Reduced noise levels enable players to concentrate better on their game, enhancing focus and precision in every shot. Quieter gameplay creates a more enjoyable experience for players and reduces disturbance to others nearby, fostering a more peaceful environment for everyone around. The pad is tested and approved by the USA Pickleball Association for the Quiet Category.

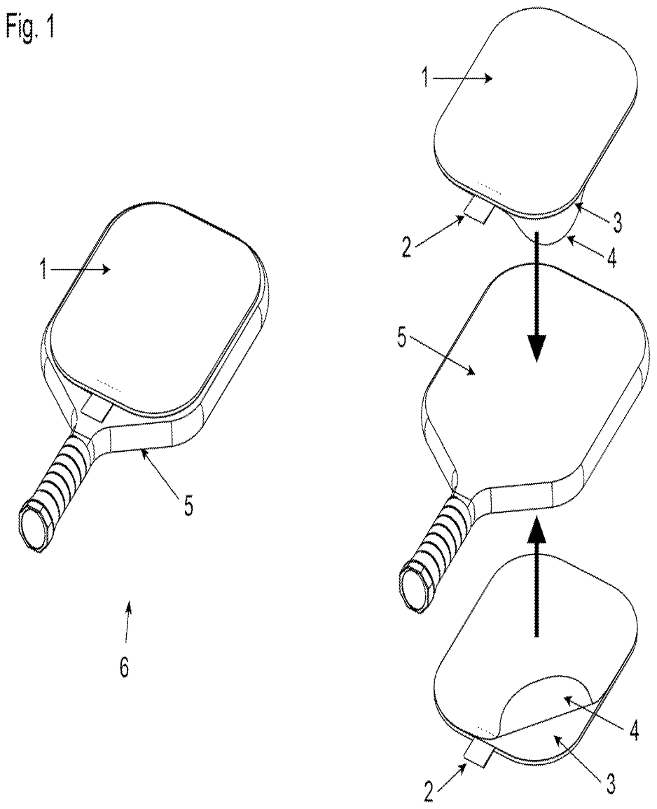

Referring now to the drawings, FIG. 1 shows the sound dampening system 6. The sound dampening system includes pad 1 applied to a paddle 5. The user can add a pad 1 to the faces of a pickleball paddle 5 to quiet the sound when the paddle 5 makes contact with the ball. The pad 1 can be either permanently installed onto the paddle or it may be removeable and re-usable multiple times depending on the type of double-sided adhesive 3 used. An exemplary adhesive is double-sided Repositionable Tape 9425 from 3M, with a high tack permanent adhesive on one side and a medium tack repositionable adhesive on the other side. Other adhesives can include Repositionable Tapes 665, 666, 9415PC, 9416, 9425HT, and 9449S, from 3M. The inventors found through testing that the best results were to have one side of the double-sided adhesive 3 be permanent adhesive that sticks onto the pad material, and the other side of the adhesive 3 that sticks onto the paddle is a re-positionable non-permanent adhesive 3 so that the pad 1 can be removed and reused multiple times.

The pads can be part of a system that includes a removable backer paper 4 installed to keep the adhesive 3 protected until first use. Once installed on the paddle 5, the inventors found that users need a method to aid in removal of the pad 1 so that it's not so hard to lift the pad 1 up and away from the paddle 5. To facilitate this, a pull tab 2 is included to help aid in an easier removal of the pad 1. Through testing, the inventors found that the pull tab 2 works best if the tab 2 is permanently affixed to the pad 1. The pull tab 2 can be made from a separate material that is attached to the pad 1 (e.g., sewed or glued to the pad 1), or the tab 2 can be made as part of the pad 1 itself. FIG. 1 shows the tab 2 located at the bottom of the pad 1, but the tab 2 can be located around any of the sides of the pad 1.

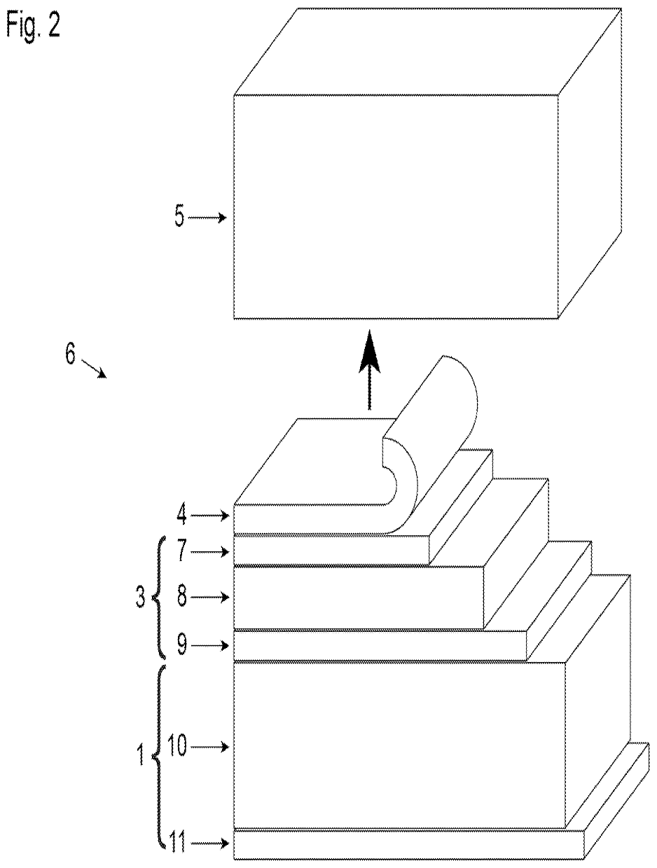

FIG. 2 shows the pad 1 and adhesive layers detail. The layers are not shown to scale for ease of illustration and explanation. FIG. 2 shows how the pad 1 and adhesive 3 layers are constructed. The pad 1 includes a main pad body or substrate 10 that is constructed of an acoustic polyester fabric material. The substrate can have a thickness between 2 mm and 8 mm, and can have a density between 200 g/m² and 3000 g/m². An exemplary embodiment has a density of 600 g/m² density and a 4 mm thickness. The pad can be constructed from several different materials, including but not limited to, polyester, PET, acoustic fabric, felt, wool, flocking, cotton, cork, rubber, neoprene, and/or foam, and combinations thereof. The face of the pad can optionally include graphics 11. The graphics 11 can be added by several methods, including but not limited to, digital printing, silk screen printed, offset printed, hot stamping, dying, painted, and/or stitched. The permanent side 9 of the double-sided adhesive 3 is applied onto the pad, with the next layer being the carrier film backing 8, then the re-positionable adhesive layer 7, and then the removable release liner paper 4 that is typically thrown away once removed but could be kept and re-used. The pad is adhered to a paddle 5 by removing the paper release liner (if applicable) and placing the re-positionable adhesive 7 onto the paddle 5.

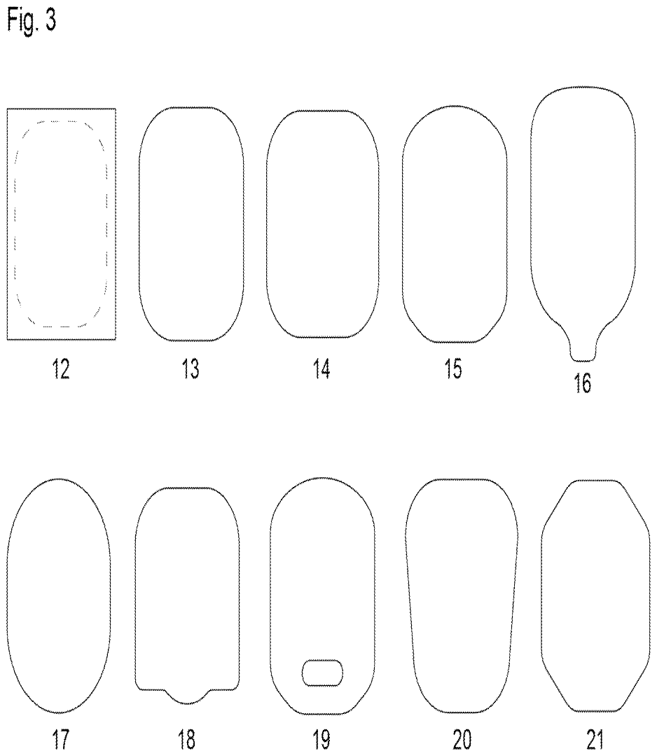

As can be seen in FIG. 3, several possible shapes to match or closely match the wide range of paddles currently on the market today. In a rudimentary embodiment, the pad 5 be a rectangular sheet that would allow the user to cut the pad material to match the user's paddle shape 12. However, this is less preferred since the hand-cut shape will be aesthetically unpleasing. Preferred precision cut shapes include a rectangle with radiused corners 13, a square with radiused corners 14, and a rectangle with rounded top 15. These shapes 13-15 cover the vast majority of paddles currently available on the market today. Additional shapes can be produced (including but not limited to e.g. pad shapes 16-21), as well as customized shapes for individual users.

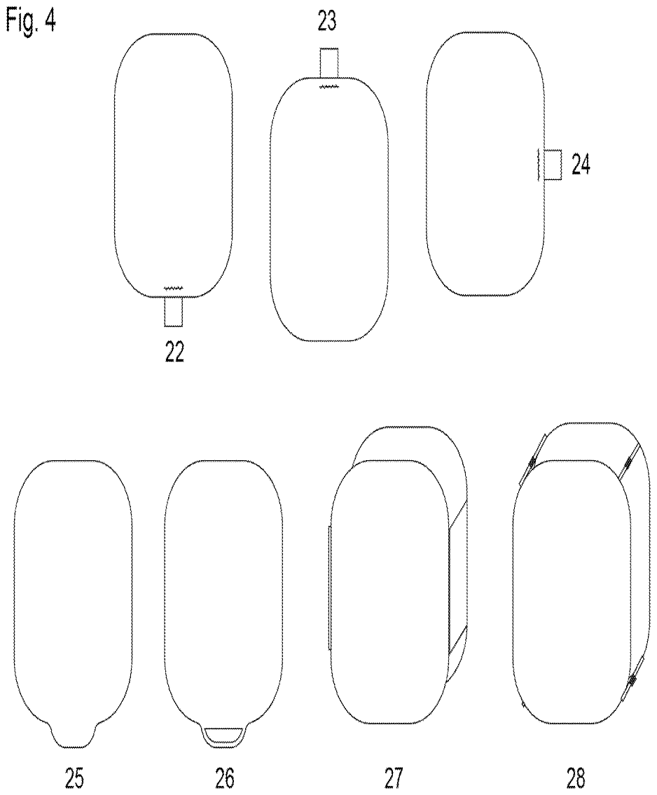

FIG. 4 shows various exemplary embodiments of pull tab 2 attachment arrangements. The pad 1 can be affixed to the paddle 5 is several ways. The pull tab 2 used to remove the pad 1 from the paddle 5 can be configured in multiple ways. An exemplary embodiment can include using adhesive or glue. Further exemplary embodiments include placing the pull tab 2 along the bottom 22, on the side 23, or on the top 24. When the tab 2 is positioned along the bottom 22, the tab is situated just above the handle of the paddle 5 (as can be seen in FIG. 1). The tab can be integrated or intrinsic with the sheet of the pad 1 as a solid tab 25, or having a band attached 26 made of from rope, string, nylon, silicone, rubber, elastic material, or a rigid material with or without a finger hole cutout. The pad can be formed into a single elastic sleeve 27 that attaches both pads together and slides over the paddle 5. The pad can be formed with bands or adjustable straps 28 that attach the two pads together and onto paddle 5. Further, the pad 1 can be affixed using magnets, screws, zippers.

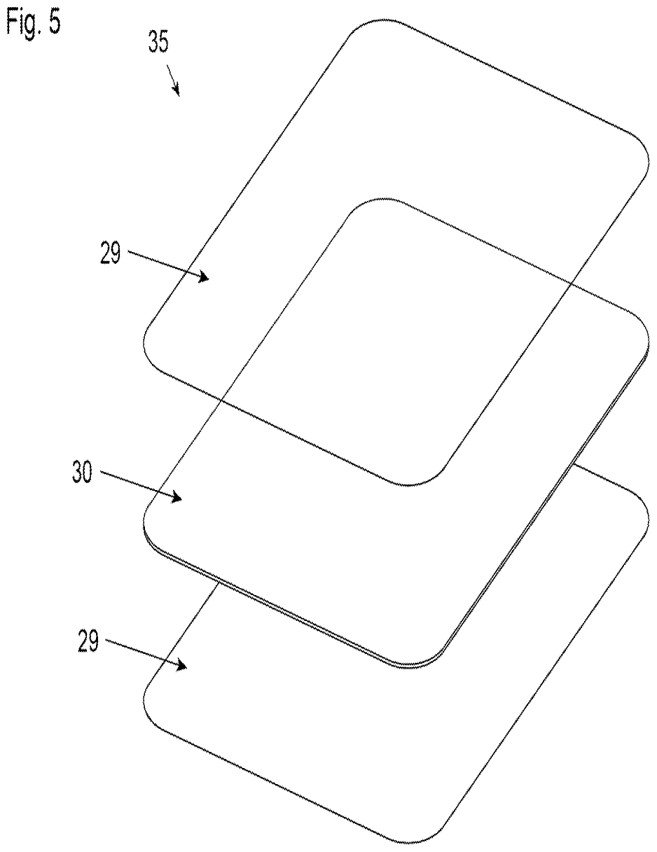

FIG. 5 shows an exemplary storage system for the removeable pads 35. The storage board 30 is a reuseable device for storing the pads between use to keep the pads and adhesive protected from any damage so that it increases the longevity of the pads 1 and adhesive 3.

When the pads 1 are adhered to the board it prevents things like dust/dirt/fuzz/hair/debris from collecting on the adhesive and reducing its tackiness over time. The pads 1 can be attached to opposing sides (i.e. both sides) of a single board such that when the pads are releasably affixed to the board, just the pad faces are exposed. Some other possible storage options could include a bag, case or protective sleeve.

An exemplary use case includes if a user wants to play pickleball and noise is not an issue, the pads are stored on the storage board. If the user wants to play a quieter game of pickleball (for example, if neighbors complain about the noise from the ball hitting the paddle), the user can remove the pads from the storage board, apply the pads to the user's paddle and play with reduced noise. Later, if the noise is not an issue, the user can remove the pads from the paddle and reapply the pads to the storage board to preserve the adhesive for future use.

The board can be made from a rigid or flexible material of varying thicknesses. Exemplary materials include, but are not limited to, paper, card stock, cardboard, plastic, ABS, PVC, polystyrene, plexiglass, fluted plastic, silicone, rubber, cork, foam, neoprene, etc. A preferred embodiment includes either a card stock paper board since these were found to be effective and economical. An exemplary board includes a paper card stock in 50 pt thickness (1.3 mm) and 1000 g/m² density.

To help keep the adhesive 3 working properly and avoid damage aside from normal use, the adhesive 3 needs to be adhered to a low surface energy surface 29 so that it can be easily released. The inventors tried several materials, starting with standard glossy and matte laminated surfaces. This was determined to be less than ideal because the adhesion of the adhesive was very strong and damaged the pad as well as the card stock paper material underneath. Polystyrene without any lamination was tested and the adhesion was found to be still very strong, but the polystyrene material was not damaged during removal of the adhesive pad. Silicone was found to provide a low surface energy surface 29 to which the adhesive can stick, but from which also easily be removed. As a result, there is no damage to the adhesive, the pad, or the board material.

The silicone 29 can be applied in several methods, including but not limited to, printing, painting, spraying, and film laminating. An exemplary embodiment includes screen printing a clear UV cured ink with a silicone additive. An alternate exemplary embodiment includes a clear silicone film laminate that uses a solvent-based silicone oil applied onto 25 μm thickness PET carrier film material with acrylic glue on the backside. This silicone film laminate is applied by a laminating process as a top layer onto both sides of the paper card stock storage board. The end product results in a storage board to which the pads can stick, yet be easily removed without any damage to any of the materials used, thus, prolonging the product's lifespan.

The storage board can include optional graphics, line drawings, or lettering. The graphics may be printed directly onto the board 30 surface by digital, offset, or screen printing, or an applied layer such as a vinyl decal. A preferred exemplary embodiment includes direct offset printing applied to both sides of the storage board 30.

The storage board 35 can be formed in various dimensions, but the overall size is preferred to be close in size to the removeable pad 1 to keep the board compact and make good use of space when storing or traveling. An exemplary embodiment includes using a size A4 (8.27″×11.69″) (210.05mm×296.92mm). An exemplary storage board paper cardstock includes a 50 point thickness (1.3mm) and 1000 g/m² density.

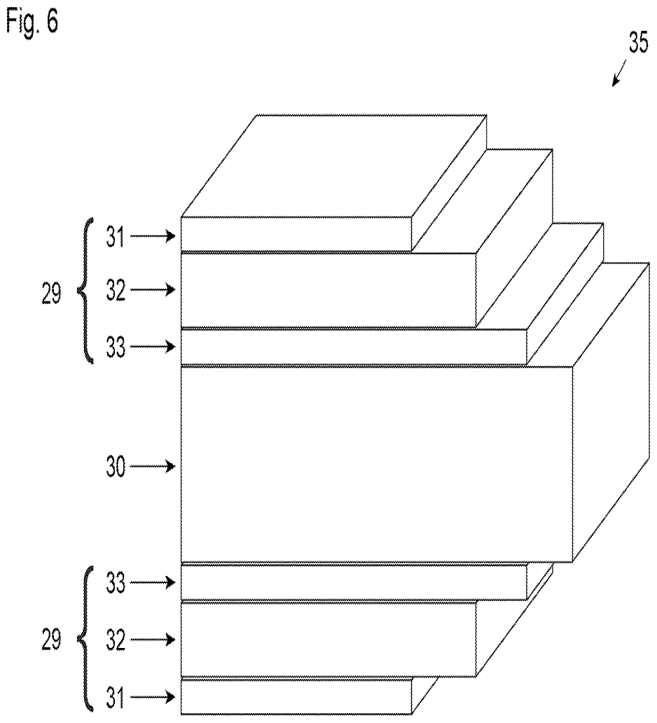

FIG. 6 shows the layers of the storage board 35 in more detail. The layers are not shown to scale for ease of illustration and explanation. An exemplary embodiment includes a double-sided storage board layers with a silicone film laminate top layer 31, a 25 μm thickness polyethylene terephthalate (PET) or unplasticized polyvinyl chloride (UPVC) carrier film backing 32, permanent acrylic cold pressed adhesive 33, and paper cardboard substrate 30 of 50 pt thickness and 1000 g/m² density.

Although the invention has been shown and described with respect to certain embodiments, equivalent alterations and modifications will occur to others skilled in the art upon the reading and understanding of this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment of the invention.

In some embodiments, the sound-dampening pad described herein is provided in an improved construction configured to reduce perceived swing weight while maintaining sound reduction performance when applied to a pickleball paddle. In certain embodiments, perceived swing weight reduction is achieved through one or more of: (i) reduced pad mass, (ii) reduced aerodynamic drag on the paddle face during a swing, (iii) reduced thickness profile, (iv) optimized pad geometry and/or placement to reduce rotational inertia, and/or (v) improved edge geometry that reduces airflow separation and turbulence.

### A. Multi-Layer Pad Constructions

In some embodiments, a sound-dampening pad comprises a multi-layer laminate including at least: (1) a cushion/damping layer; and (2) an adhesive backing layer configured to removably adhere the pad to a paddle face. In some embodiments, the pad further comprises (3) a low-drag face layer (also referred to as a “skin” layer) disposed on an impact-facing side of the pad opposite the adhesive backing. In some embodiments, the low-drag face layer comprises a polymer film, a coated textile, a polymer-coated nonwoven, or a composite face layer configured to present a smoother aerodynamic surface than an exposed fibrous cushion layer. In some embodiments, the low-drag face layer improves durability, water resistance, stain resistance, and/or cleanability.

### A1. Cushion/Damping Layer Options

In some embodiments, the cushion/damping layer comprises one or more of: polyester felt, polyester acoustic fabric, nonwoven fiber mat, needle-punched felt, spacer fabric, 3D knit structures, microcellular foam, polyurethane foam, thermoplastic elastomer foam, elastomeric foam, rubber foam, silicone foam, neoprene foam, EPDM foam, nitrile foam, or combinations thereof. In some embodiments, the cushion/damping layer comprises a multilayer damping stack including a first fibrous layer and a second layer comprising a viscoelastic polymer, elastomer, gel, or foam.

In some embodiments, the cushion/damping layer comprises a microcellular polyurethane (MCU) foam or high-performance viscoelastic polyurethane foam configured for impact energy dissipation and vibration damping (e.g., PORON-type materials or equivalent microcellular/viscoelastic polyurethane foams). In certain embodiments, the microcellular or viscoelastic polyurethane foam has a thickness from about 0.2 mm to about 3.0 mm, from about 0.5 mm to about 2.5 mm, or from about 0.5 mm to about 2.0 mm. In certain embodiments, the foam is provided in a plurality of firmness grades including soft, medium, and firm grades.

In some embodiments, the cushion/damping layer comprises expanded thermoplastic polyurethane (eTPU) foam, including bead-expanded thermoplastic polyurethane foams (e.g., Infinergy-type materials or equivalent). In certain embodiments, the eTPU foam comprises expanded beads fused into a sheet or molded layer. In certain embodiments, the eTPU foam has a thickness from about 0.5 mm to about 4.0 mm, from about 1.0 mm to about 3.5 mm, or from about 1.0 mm to about 3.0 mm. In some embodiments, the eTPU foam presents a smooth surface or a textured surface.

In some embodiments, any foam or elastomeric layer described herein may be open-cell, closed-cell, or mixed-cell/hybrid-cell. In some embodiments, a foam layer is selected from reticulated foams, microcellular foams, bead foams, chemically blown foams, mechanically frothed foams, or combinations thereof. In some embodiments, the foam layer may comprise any thermoplastic elastomer (TPE), thermoplastic polyurethane (TPU), polyurethane (PU), silicone, olefinic, styrenic, or other elastomeric foam formulation configured for impact damping and/or vibration damping.

In some embodiments, the cushion/damping layer is configured to reduce audible impact sound and/or reduce high-frequency ringing of the paddle by damping vibration of the paddle face. In certain embodiments, the cushion/damping layer is configured to attenuate frequencies above approximately 1 kHz, above approximately 2 kHz, above approximately 3kHz, above approximately 4 kHz, or above approximately 5 kHz.

### A2. Thickness, Basis Weight, and Density Ranges

In some embodiments, the pad has an overall thickness in a range from about 0.5 mm to about 8 mm, from about 0.8 mm to about 6 mm, from about 1 mm to about 5 mm, from about 1 mm to about 4 mm, from about 1.5 mm to about 3.5 mm, from about 2 mm to about 3.5 mm, or from about 2 mm to about 3 mm. In some embodiments, the cushion/damping layer has a thickness from about 0.5 mm to about 6 mm, from about 1 mm to about 5 mm, or from about 1 mm to about 3.5 mm.

In some embodiments where the cushion/damping layer is a fibrous sheet, the fibrous sheet has a basis weight (GSM) in a range from about 150 g/m² to about 1500 g/m², from about 200 g/m² to about 1200 g/m², from about 250 g/m² to about 900 g/m², from about 300 g/m² to about 800 g/m², from about 350 g/m² to about 700 g/m², or from about 400 g/m² to about 650 g/m².

In some embodiments, the pad is configured to reduce total added mass to a paddle while maintaining sound damping performance. In certain embodiments, two pads applied to opposite faces of a paddle add less than about 80 grams, less than about 70 grams, less than about 60 grams, less than about 55 grams, less than about 50 grams, less than about 45 grams, less than about 40 grams, or less than about 35 grams total.

### A3. Low-Drag Face Layer (“Skin”) Options

In some embodiments, the low-drag face layer comprises a film or sheet of one or more of: TPU (thermoplastic polyurethane), TPE, TPO, PET, polyolefin, polyurethane, nylon, polycarbonate, silicone-based polymers, acrylic-based polymers, or combinations thereof. In some embodiments, the low-drag face layer has a thickness from about 0.01 mm to about 0.50 mm, from about 0.02 mm to about 0.30 mm, from about 0.03 mm to about 0.20 mm, from about 0.05 mm to about 0.15 mm, or from about 0.05 mm to about 0.12 mm.

In some embodiments, the low-drag face layer is fully laminated across substantially the entire pad surface so as to reduce or prevent formation of air gaps between the face layer and the cushion/damping layer. In certain embodiments, the low-drag face layer is laminated using heat and pressure, adhesive lamination, ultrasonic bonding, radio-frequency bonding, or combinations thereof.

In some embodiments, a tie layer is disposed between the cushion/damping layer and the low-drag face layer. In some embodiments, the tie layer comprises a hot-melt adhesive film, a TPU adhesive film, a polyurethane adhesive film, a copolyester adhesive film, an acrylic adhesive film, or combinations thereof, configured to increase bond strength and reduce voids. In some embodiments, the tie layer is configured to provide a substantially continuous bond interface that reduces “membrane-like” acoustic effects that may occur if voids or air gaps are present.

In some embodiments, the low-drag face layer comprises a TPU film that is transparent, translucent, or opaque, and may be provided in any color including solid colors, patterns, or gradients. In some embodiments, the low-drag face layer includes printed graphics, logos, indicia, or decorative patterns formed by screen printing, digital printing, dye sublimation, transfer printing, or other printing methods. In some embodiments, the low-drag face layer includes one or more functional coatings including abrasion-resistant coatings, matte coatings, hydrophobic/oleophobic coatings, UV-resistant coatings, antimicrobial coatings, or combinations thereof.

### A4. Texture and Spin-Control Features

In some embodiments, the low-drag face layer is configured to preserve or enhance ball spin capability while reducing aerodynamic drag. In certain embodiments, the low-drag face layer comprises a micro-textured or embossed surface configured to increase frictional engagement with a pickleball relative to a smooth glossy film. In some embodiments, the low-drag face layer is configured with macro-texture and/or micro-texture to increase friction for ball spin while maintaining reduced aerodynamic drag relative to an exposed fibrous surface.

In some embodiments, the low-drag face layer has an embossed texture comprising ridges, dimples, stippling, micro-pyramids, micro-lines, or random microtexture. In some embodiments, the texture depth is from about 1 micron to about 200 microns, from about 5 microns to about 150 microns, or from about 10 microns to about 100 microns. In some embodiments, the low-drag face layer includes a matte finish, a satin finish, a frosted finish, or a patterned finish.

In some embodiments, the low-drag face layer includes perforations, micro-perforations, pores, channels, or vent structures. In certain embodiments, perforations are configured to reduce membrane-like acoustic effects and/or to allow partial compliance of the underlying cushion/damping layer. In some embodiments, perforation diameters are in a range from about 0.05 mm to about 1.0 mm, from about 0.1 mm to about 0.7 mm, or from about 0.2 mm to about 0.5 mm, and perforation open area is in a range from about 0.1% to about 10%, from about 0.5% to about 5%, or from about 1% to about 3%. In some embodiments, micro-perforations are formed by laser perforation, mechanical pin perforation, or emboss/perforation processes.

### A5. Damping Films and Constrained-Layer Damping

In some embodiments, the pad includes one or more damping film layers comprising a viscoelastic damping polymer configured to dissipate vibrational energy. In certain embodiments, the pad comprises a constrained-layer damping (CLD) structure including a viscoelastic layer disposed between two layers having differing stiffness. In some embodiments, a damping film layer has a thickness from about 0.02 mm to about 1.0 mm, from about 0.05 mm to about 0.5 mm, or from about 0.1 mm to about 0.3 mm.

In some embodiments, the pad includes a thin stiff layer, constraining layer, or backing layer comprising a polymer film, fiber-reinforced layer, thin sheet, coated layer, or combinations thereof, configured to cooperate with a viscoelastic layer to improve damping.

### A6. Other Damping Layer Materials

In some embodiments, the cushion/damping layer comprises other lightweight vibration-damping materials including thermoplastic elastomer (TPE) sheets, viscoelastic polyurethane gels, elastomeric fiber composites, nonwoven composites, spacer fabrics, 3D knit structures, or multi-material laminates configured to reduce impact sound and/or vibration.

### B. Edge Geometry for Aerodynamic Performance and Durability

In some embodiments, the pad includes an aerodynamic perimeter edge configured to reduce airflow separation and turbulence during a swing. In some embodiments, the pad includes a beveled edge around at least a portion of the perimeter. In certain embodiments, the bevel angle is from about 20° to about 70°, from about 30° to about 60°, or about 45°.

In some embodiments, the pad includes a tapered edge formed by skiving, grinding, die-cut beveling, compression forming, heat forming, or combinations thereof. In some embodiments, the pad includes an edge seal configured to reduce fraying of a fibrous layer and provide a smoother aerodynamic transition from the paddle surface to the pad surface. In certain embodiments, the edge seal comprises a polymer film strip (e.g., TPU or PET) wrapped over at least a portion of the pad edge, bonded by heat/pressure or adhesive. In some embodiments, the edge seal covers the entire perimeter. In some embodiments, the edge seal is co-laminated with the low-drag face layer and/or the adhesive backing layer.

### C. Adhesive Structures for Reduced Mass and Improved Feel

In some embodiments, the adhesive backing layer comprises a pressure-sensitive adhesive configured for removability and repositionability. In some embodiments, the adhesive backing comprises a single adhesive layer. In other embodiments, the adhesive backing comprises two or more layers including a differential adhesive structure having: (i) a first adhesive region configured to bond strongly to the pad structure; and (ii) a second adhesive region configured to bond removably to a pickleball paddle face.

In some embodiments, the adhesive backing is applied as a patterned adhesive to reduce weight and/or improve compliance and damping. In certain embodiments, patterned adhesive comprises a perimeter band, islands, dots, stripes, grids, lattices, or combinations thereof. In some embodiments, patterned adhesive coverage is less than about 100%, less than about 90%, less than about 80%, less than about 70%, less than about 60%, less than about 50%, or less than about 40% of the pad area.

In some embodiments, the adhesive backing is configured to reduce residue on the paddle surface and/or preserve removability after repeated use. In certain embodiments, the adhesive backing is compatible with storage on a reusable storage board having a low-surface-energy layer.

### D. Hybrid Constructions for Reduced Swing-Weight Perception

In some embodiments, the pad is configured to reduce perceived swing weight by distributing mass closer to the paddle handle relative to the paddle tip. In some embodiments, the pad geometry is selected such that a majority of pad area is disposed in a central region of the paddle face and/or is reduced near an outer perimeter or near the paddle tip.

In some embodiments, the pad includes cutouts, relief regions, or reduced thickness regions to reduce mass while preserving damping in selected areas corresponding to vibration modes of the paddle face. In some embodiments, the pad includes a thickness gradient, with greater thickness in a central strike region and reduced thickness at the perimeter.

### E. Removal-Aid Features Compatible With Low Drag

In some embodiments, the pad includes a removal-aid feature configured to facilitate removal from the paddle while maintaining a low-drag outer surface. In some embodiments, the removal-aid feature comprises a lift edge, a stiffened edge region, a laminated strip, a folded film flap, or combinations thereof. In some embodiments, the removal-aid feature is integrated into the edge seal and/or the low-drag face layer.

### F. Performance Definitions and Testing

In some embodiments, the pad is configured to reduce sound pressure level produced by a pickleball striking a paddle by at least about 2 dB, at least about 3 dB, at least about 4 dB, at least about 5 dB, at least about 6 dB, at least about 7 dB, at least about 8 dB, at least about 9 dB, or at least about 10 dB, as measured at a fixed distance using a consistent impact procedure. In some embodiments, the pad is configured to reduce an audible “high frequency ring” component of the impact sound relative to an unmodified paddle. In certain embodiments, such reduction is characterized by reduced spectral amplitude in frequency bands above about 2 kHz, above about 3 kHz, above about 4 kHz, or above about 5 kHz.

In some embodiments, the pad is configured to reduce perceived aerodynamic drag relative to a pad having an exposed fibrous face layer. In certain embodiments, reduced drag is achieved by providing a low-drag face layer and/or beveled or sealed edges.

### G. Example Embodiment Sets (Non-Limiting)

In one non-limiting example, the pad comprises: a fibrous acoustic layer (e.g., polyester felt) having a thickness of about 1-3.5 mm, a low-drag polymer face film (e.g., a micro-textured TPU film) having a thickness of about 0.05-0.12 mm, and a repositionable adhesive backing.

In another non-limiting example, the pad comprises: a microcellular viscoelastic polyurethane (MCU) foam layer (e.g., PORON-type) having a thickness of about 0.5-2.0 mm and selected from soft, medium, and firm grades; an optional tie layer; a low-drag polymer face film (e.g., a matte or micro-embossed TPU film) having a thickness of about 0.03-0.15 mm; and a repositionable adhesive backing that may be full coverage or patterned.

In another non-limiting example, the pad comprises: an expanded thermoplastic polyurethane (eTPU) layer (e.g., Infinergy-type) having a thickness of about 1-3 mm, a low-drag polymer face film having a thickness of about 0.03-0.15 mm that may be colored and/or printed, and a patterned adhesive backing.

In another non-limiting example, the pad comprises: a fibrous acoustic layer having a thickness of about 2-4 mm, an edge seal film wrapping at least a portion of the perimeter, and a reusable adhesive backing configured for repeated storage on a low-surface-energy storage board.

In another non-limiting example, the pad comprises a constrained-layer damping structure comprising a constraining layer, a viscoelastic damping film layer having a thickness of about 0.05-0.3 mm, a low-drag face film, and a repositionable adhesive backing.

What is claimed is:

1. A sound-dampening pad configured to be removably adhered to a face of a pickleball paddle, the sound-dampening pad comprising:
(a) a cushion/damping core layer having a thickness from about 0.5 mm to about 3.5 mm; and
(b) a repositionable pressure sensitive adhesive backing coupled to the cushion/damping core layer;
wherein the cushion/damping core layer comprises at least one of:
(i) a microcellular viscoelastic polyurethane foam layer, or
(ii) an expanded thermoplastic polyurethane (eTPU) foam layer; and
wherein, when adhered to the pickleball paddle, the pad is configured to reduce audible impact sound produced by a pickleball striking the pickleball paddle relative to the pickleball paddle without the pad.

2. The sound-dampening pad of claim 1, wherein the cushion/damping core layer has a thickness from about 0.8 mm to about 3.0 mm.

3. The sound-dampening pad of claim 1, wherein the cushion/damping core layer comprises the microcellular viscoelastic polyurethane foam layer having a thickness from about 0.5 mm to about 2.0 mm, and selectable from soft, medium, and firm grades.

4. The sound-dampening pad of claim 1, wherein the cushion/damping core layer comprises the eTPU foam layer having a thickness from about 1.0 mm to about 3.0 mm.

5. The sound-dampening pad of claim 1, wherein the cushion/damping core layer is open-cell, closed-cell, or hybrid-cell.

6. A sound-dampening pad configured to be removably adhered to a face of a pickleball paddle, the sound-dampening pad comprising:
(a) a cushion/damping layer;
(b) a repositionable adhesive backing coupled to the cushion/damping layer; and
(c) a low-drag face layer disposed on an impact-facing side of the pad opposite the repositionable adhesive backing;
wherein the cushion/damping layer comprises at least one of (i) a microcellular viscoelastic polyurethane foam layer or (ii) an expanded thermoplastic polyurethane (eTPU) foam layer, and has a thickness from about 0.5 mm to about 3.5 mm; and
wherein the low-drag face layer comprises a polymer film having a thickness from about 0.02 mm to about 0.30 mm and is configured to present a smoother aerodynamic surface during a paddle swing than an exposed cushion/damping layer surface.

7. The sound-dampening pad of claim 6, wherein the polymer film comprises TPU and has a thickness from about 0.05 mm to about 0.15 mm.

8. The sound-dampening pad of claim 6, further comprising a tie layer between the cushion/damping layer and the low-drag face layer, wherein the tie layer comprises a hot-melt adhesive film configured to reduce air gaps.

9. The sound-dampening pad of claim 6, wherein the low-drag face layer is micro-textured or embossed, optionally includes micro-perforations having a diameter from about 0.05 mm to about 1.0 mm and an open area from about 0.1 percent to about 10 percent, and is optionally colored and/or includes printed indicia.

10. The sound-dampening pad of claim 6, wherein the pad comprises an aerodynamic perimeter edge comprising at least one of (i) a beveled edge having an angle from about 20 degrees to about 70 degrees, or (ii) an edge seal comprising a polymer film strip wrapped over at least a portion of a perimeter edge of the pad.

11. A method of making a sound-dampening pad for a pickleball paddle, comprising:
(a) providing a cushion/damping core layer comprising a microcellular viscoelastic polyurethane foam layer and/or an expanded thermoplastic polyurethane (eTPU) foam layer, the core layer having a thickness from about 0.5 mm to about 3.5 mm;
(b) laminating a polymer film to an impact-facing side of the core layer to form a low-drag face layer, the polymer film having a thickness from about 0.02 mm to about 0.30 mm;
(c) coupling a repositionable adhesive backing to an opposite side of the core layer;
wherein laminating comprises bonding the polymer film to the core layer using heat and pressure and/or a tie layer to reduce air gaps between the polymer film and the core layer.

12. The method of claim 11, wherein the polymer film comprises TPU and has a thickness from about 0.05 mm to about 0.15 mm, and wherein the repositionable adhesive backing comprises a pressure-sensitive adhesive configured for repeated cycles of removal and reapplication.
